(19) United States
(12) Patent Application Publication
(10) Pub. No.: US 2004/0111860 A1
(43) Pub. Date: Jun. 17, 2004

(54) Edge connector removal tool

(76) Inventors: Carlos E. Ramirez, San Sabastian, PR (US); Angel Martir, Aguada, PR (US); Julio H. Monroig, San Sebastian, PR (US); Edwin Del Moral, Isabela, PR (US)

Correspondence Address: HEWLETT-PACKARD COMPANY, Intellectual Property Administration, P.O. Box 272400, Fort Collins, CO, 80527-2400, US

(21) Appl. No.: 10/318,832

(22) Filed: Dec. 13, 2002

(51) Int. Cl. B23P 19/04

(52) U.S. Cl. 29/426.5; 29/764; 29/267

(57) ABSTRACT

A tool for removing edge connectors from circuit boards includes an elongated handle having a first end, a first head at the first end of the handle shaped to engage a portion of an edge connector, and a second removable head for attachment to the handle in opposition to the first head, the second head also being shaped to engage a portion of an edge connector.

### BACKGROUND

Printed circuit boards are ubiquitous in the world today. They can be found in thousands of products ranging from toys and computers to remote controllers. Printed circuit boards are generally fabricated using a relatively thin piece of fiberglass with thin copper “wires” or traces that are printed onto a surface of the board. Electronic components are then secured to the board and interconnected by the copper traces to form a completed device.

Electronic devices are assembled on printed circuit boards (“PCBs”) because such circuit boards are relatively easy to mass produce and support attachment and interconnection of numerous electronic devices. In the same way that it is relatively inexpensive to print ink onto a sheet of paper, it is typically inexpensive to “print” copper traces onto a sheet of fiberglass. And, a wide variety of trace configuration can be readily produced. It is also relatively simple to place different component parts (chips, transistors, etc.) in appropriate locations on the printed circuit board and then solder those components to secure them to the board and connect them to the copper traces.

To connect a PCB to a computer or other device, including another PCB, an edge connector is often used. As the name suggests, the edge connector is attached to an edge of the printed circuit board and generally has a row of broad metallic tracks or teeth that provide the electrical connection to the traces on the PCB. However, when edge connectors need to be removed from a PCB, extracting the edge connector can be quite difficult. Currently, common tools, such as pliers, are used to the remove edge connectors.

The use of such common tools to remove an edge connector sometimes results in damage to the PCB, adjacent components on the PCB, or the edge connector itself. Damaged PCBs, components, and edge connectors must then either be repaired or replaced.

### SUMMARY

A tool for removing edge connectors from circuit boards includes an elongated handle having a first end, a first head at the first end of the handle shaped to engage a portion of an edge connector, and a second removable head for attachment to the handle in opposition to the first head, the second head also being shaped to engage a portion of an edge connector.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is top view of an edge connector removal tool handle according to one embodiment of the present invention.

FIG. 2 is a side view of the edge connector removal tool handle of FIG. 1.

FIG. 3 is a side view of a clamp or jaw for attachment to the tool handle of FIG. 1 according to one embodiment of the present invention.

FIG. 4 is a top view of the clamp or jaw of FIG. 3.

FIG. 5 is a perspective view of an edge connector removal tool according to one embodiment of the present invention.

FIG. 6 is a side view of a PCB with an installed edge connector according to one embodiment of the present invention.

FIG. 7 is a perspective view of an edge connector removal tool being engaged with an edge connector according to one embodiment of the present invention.

FIG. 8 is a side view of the edge connector removal tool of FIG. 6 fully engaged with the edge connector according to one embodiment of the present invention.

FIG. 9 is a side view of the edge connector removal tool of FIG. 6 fully engaged with a different edge connector according to another embodiment of the present invention.

Throughout the drawings, identical reference numbers designate similar, but not necessarily identical, elements.

### DETAILED DESCRIPTION

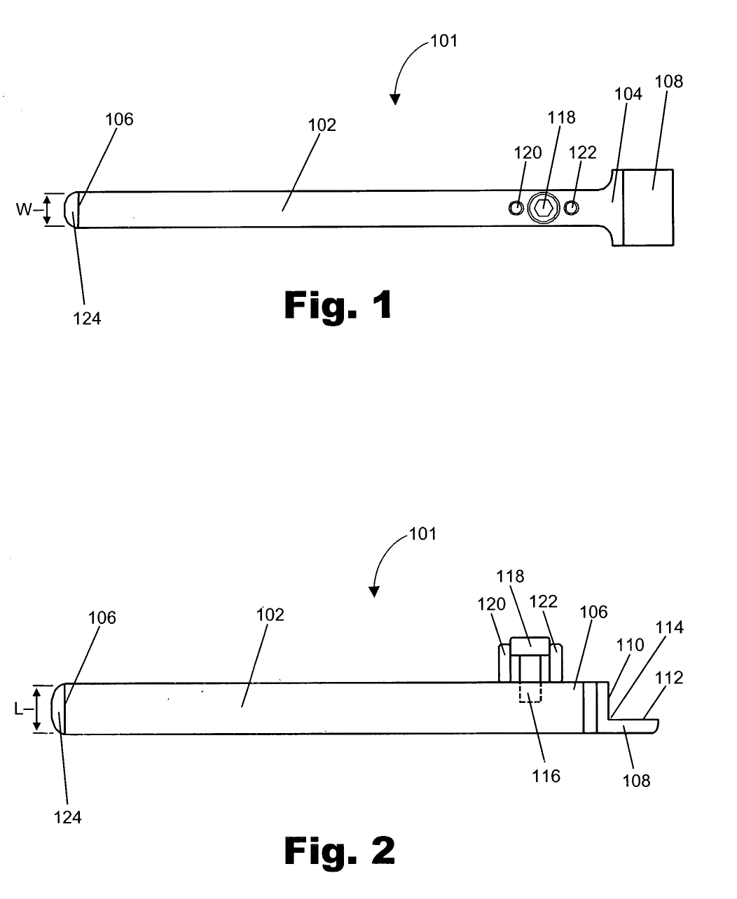

A tool, that will be described herein, can be used to remove an edge connector from a printed circuit board (PCB) without damaging the board or the connector. Turning to FIGS. 1-2, a handle (101) is illustrated for an edge connector removal tool according to one embodiment of the present invention. The handle (101) comprises, for example, a lever arm (102), as shown. According to the embodiment of FIG. 1, the lever arm (102) has a first end (104) and a second end (106). The lever arm (102) may be made of structural materials, such as plastics, metals, composites or other acceptable material. In the present embodiment, the lever arm (102) is made of commercially available D-2 steel. The lever arm (102) is rectangular in cross-section, however, other cross-sectional shapes may also be used.

The first end (104) of the lever arm (102) defines a first head (108). The first head (108) extends beyond the width (W) of the lever arm (102), but is preferably flush with a height (H, FIG. 2) of the lever arm (102). However, other dimensions for the first head (108) that are smaller or larger than the height (H, FIG. 2) and width (W, FIG. 1) of the illustrated lever arm (102) may also be used.

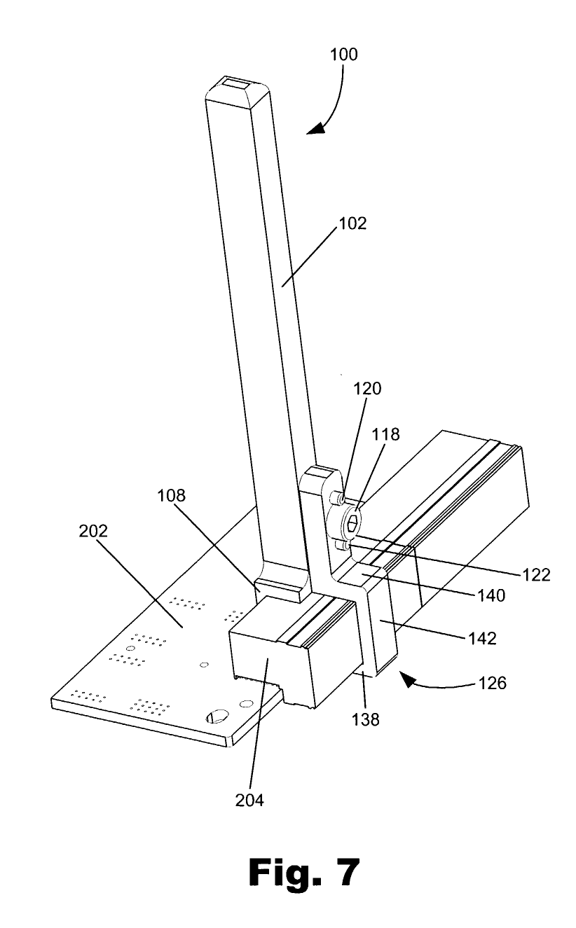

The first head (108) includes a first surface (110) arranged substantially perpendicular to a second surface (112). The first surface (110) may be arranged transverse to the lever arm (102), as shown. The first and second surfaces (110 and 112) form an interior corner (114) receptive of an edge connector (204, FIG. 7) or other apparatus.

In addition, the first end (104) may include a first recess such as a threaded recess (116, FIG. 2) receptive of a connector, such as a hexagonal screw (118). The hexagonal screw (118) is shown installed in the recess (116) and in between two optional pins, a first pin (120) and a second pin (122). The first and second pins (120 and 122) may be integral to the lever arm (102), or they may be separately inserted into recesses similar to the threaded recess (116) receptive of the hexagonal screw (118).

The second end (106) of the lever arm (102) may include a rounded edge (124), but this is not necessarily so. The second end (106) may also include a blunt, rectangular surface or other surface.

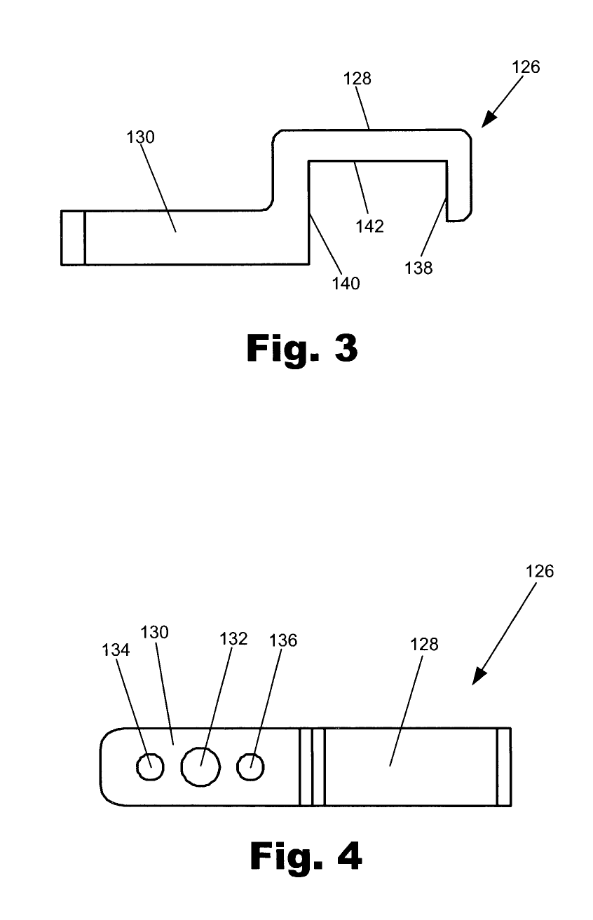

The hexagonal screw (118) facilitates the connection of the lever arm (102) to a jaw or clamp, for example a second head (126), shown in FIGS. 3-4. The second head (126) of FIGS. 3-4 includes a substantially C-shaped portion (128) and a neck portion (130). The neck portion (130) includes a first hole (132, FIG. 4) for alignment with the threaded recess (116) of the lever arm (102). The first hole (132) is sized to allow the hexagonal screw (116) to extend therethrough.

In the embodiment shown, the neck portion (130) also includes second and third holes (134 and 136) receptive of the optional first and second pins (120 and 122, respectively). The first and second pins (120 and 122) facilitate the alignment of the second head (126) with the first head (108).

The second head (126) is shaped to mate with a printed circuit board edge connector (208, FIG. 7). The second head (126) includes first and second members (138 and 140) arranged substantially parallel to one another and connected to one another in the present embodiment by a third member (142) extending between the first and second members (138 and 140). These members may be integrally formed, as may the entire second head (126), or may be composed on any number of constituent parts.

According to the embodiment of FIGS. 3-4, the first member (138) is shorter than the second member (140). The second head (126) may be made of structural materials such as metal, plastic, and/or any other appropriate materials. In the present embodiment, the second head (126) may be made of tool steel. It will be appreciated that the neck portion (130) or other elements of the second head (126) may be increased or decreased in length to fit around variously sized edge connectors.

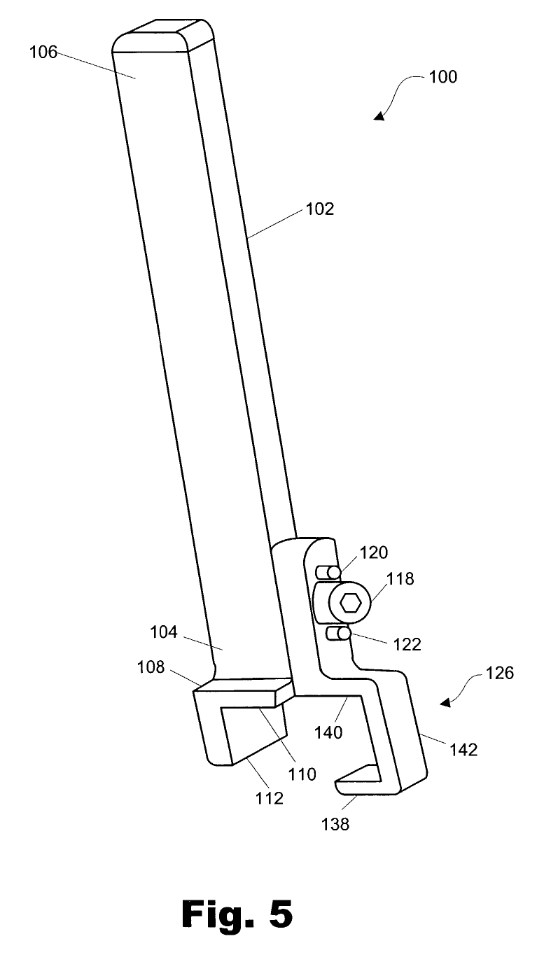

Turning next to FIG. 5, a perspective view of an assembled edge connector removal tool (100) according to one embodiment is shown. In the assembly of FIG. 5, the lever arm (102) is connected to the second head (126), as shown.

According to the embodiment of FIG. 5, the first and second pins (120 and 122) extend through the second head (126). The pins (120 and 122) are useful to align the second head with the lever arm (102). However, as has been noted, the pins (120 and 122) are optional. Thus, in some embodiments the pins may be omitted entirely, or only a single pin may be used. In some other embodiments, the first and second pins (120 and 122) may only extend partially through the second head (126).

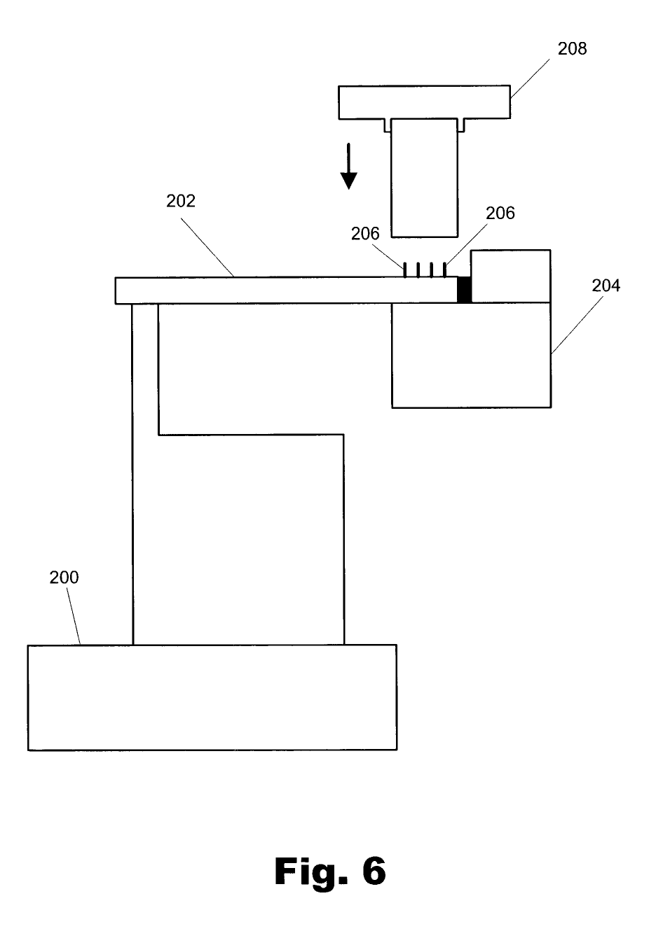

The hexagonal screw (118) attaches the second head (126) to first head (108) of the lever arm (102). The first surface (110) of the first head (108) is substantially coplanar in the present embodiment with the second member (140) of the second head (126). The combination of the first head (108) and the second head (126) create a substantially rectangular shape, although the shape is open to facilitate receipt of an edge connector (204, FIG. 6).

Turning next to FIG. 6, there is shown an electronic device or fixture (200) including a printed circuit board (PCB) (202) and an installed edge connector (204). The edge connector (204), as shown, may include multiple pins (206) inserted into the PCB (202). Many edge connectors (204) do not include any pins (206) inserted into the PCB (202). If, however, the edge connector (204) does include multiple pins (206), and it becomes necessary to remove the edge connector (204), a press fit repair fixture (208) may be used to disengage the multiple pins (206) from the PCB (202).

The press fit repair fixture (208) is pressed into the pins (206) and toward the circuit board (202). This forces the pins (206) back through the circuit board (202) and loosens the engagement between the connector (204) and the circuit board (202).

When the multiple pins (206) of the edge connector (204) are disconnected from the PCB (202) (in embodiments that have pins (206)), the edge connector (204) may be more easily removed from the PCB (202) by the application of force on the edge connector (204) as will be shown in FIG. 7. In embodiments that have no pins, there is no need to use the press fit repair fixture (208) prior to removal of the edge connector (204).

FIG. 7 illustrates the use of the assembled tool of FIG. 5 to safely remove the edge connector (204). Turning to FIG. 7, the lever arm (102) may be placed over the edge connector (204) and the second head (126) may be mounted to the lever arm (102) in a clamp-like configuration, as shown. The first and second surfaces (112 and 114) of the first head (108) and the first, second and third members (138, 140, 142) of the second head (126) extend around the edge connector (204) when the second head is installed onto the lever arm (102). As mentioned above, the second head may be connected to the lever arm (102) by inserting the first and second pins (120 and 122) into the corresponding holes (134 and 136, FIG. 4) of the second head (126) and securing the hexagonal screw (118) through the first hole (132, FIG. 3) of the second head (126) and into the threaded recess (116, FIG. 2).

It will be appreciated that there may be multiple second heads (128) created with various dimensions to match the different dimensions of various edge connectors, and that each of the multiple second heads (128) can be interchangeably connected to the lever arm (102). Accordingly, a single lever arm (102) may be used with any second head (126) for use in the removal of any edge connector. Further, in some instances, there may be several similar tools (100) used simultaneously to remove the edge connector (204) when the edge connector (204) is long or very tightly attached.

In addition, it will be understood by those of skill in the art having the benefit of this disclosure that in some embodiments the lever arm (102) may be integral with the second head (126) to form a single-piece tool. In single-piece tool configurations, there may be many single-piece tools made of various sizes with an open channel for receiving differently shaped edge connectors.

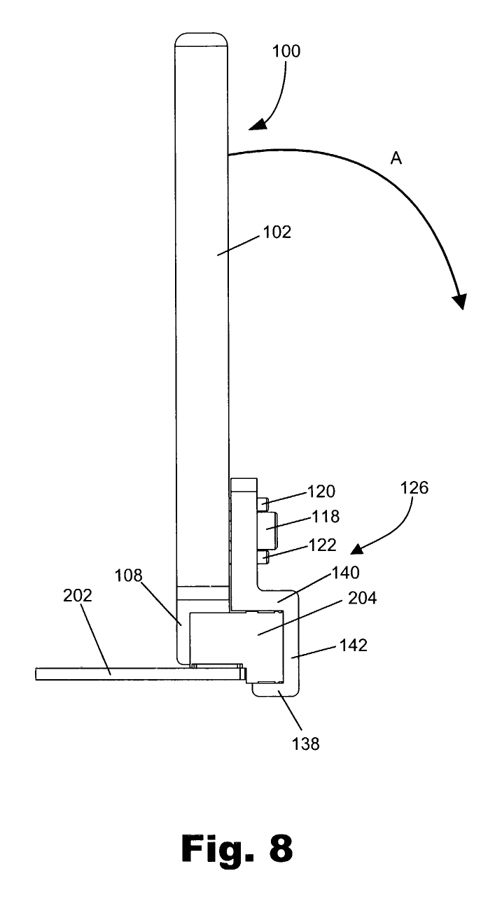

When the second head (126) is connected to the lever arm (102), the tool (100) is in the position shown in FIG. 8. With the first and second heads (108 and 126) secured around the edge connector (204), an operator may apply a force to the lever arm (102), rotating the lever arm around the edge of the circuit board (202), as shown by the arrow (A) in FIG. 8. This action can easily remove the edge connector (204) from the PCB (202) without damaging either the edge connector (204) or the PCB (202).

As shown in FIG. 8, the assembled tool (100) engages four sides of the edge connector (204). This allows the tool (100) to exert the force needed to remove the edge connector (204) without damage to the board (202) or the connector (204) itself. In some embodiments, the tool may engage only three sides of the edge connector. In such an embodiment, member (138) or surface (112) might be omitted.

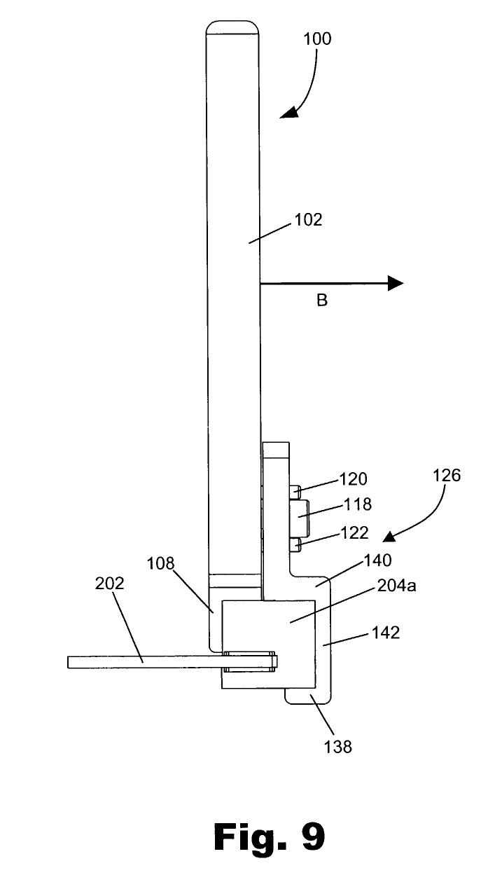

FIG. 9 illustrates the use of the edge connector removal tool with a different type of edge connector (204a). As shown in FIG. 9, the edge connector may engage opposite sides of the circuit board (202).

In such a case, the edge connector removal tool (100) is secured to the edge connector (204a) in the same manner described above. A transverse force is then applied to the tool (100). This force is preferably parallel with the plane of the circuit board (202) and away form the circuit board (202). The arrow (B) in FIG. 9 illustrates the direction of this force.

This action allows the tool (100) to exert the force needed to remove the edge connector (204a) without damage to the board (202) or the connector (204a) itself. Consequently, the tool (100) described herein can be used to safely remove a variety of differently configured edge connectors.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A tool for removing edge connectors from circuit boards, said tool comprising:
an elongated handle having a first end;
a first head at said first end of said handle shaped to engage a portion of an edge connector; and
a second removable head for attachment to said handle in opposition to said first head, said second head also being shaped to engage a portion of an edge connector.

2. The tool of claim 1, wherein said handle further comprises a recess at said first end receptive of a connector for securing said second head to said handle, said second head comprising a first hole for alignment with said first recess, said connector extending though said first hole in said second head and into said first recess.

3. The tool of claim 2, wherein said connector comprises a screw, said first recess including threads receptive of said screw.

4. The tool of claim 2, further comprising at least a first pin protruding from said elongated handle or said second head for facilitating alignment of said first recess and said first hole.

5. The tool of claim 4, further comprising a pin hole, receptive of said first pin, in said second head or said elongated handle, wherein said first one pin extends into or through said pin hole.

6. The tool of claim 5, further comprising a second pin protruding from said elongated handle or said second head for facilitating alignment of said first recess and said first hole.

7. The tool of claim 6, further comprising a second pin hole, receptive of said second pin, in said second head or said elongated handle, wherein said first one pin extends into or through said pin hole.

8. The tool of claim 1, wherein said second head comprises a substantially C-shaped portion.

9. The tool of claim 8, wherein said C-shaped portion of said second head is sized to engage an edge connector.

10. The tool of claim 1, wherein said first head of said elongated handle comprises first and second surfaces substantially normal to each other for engaging a portion of an edge connector.

11. The tool of claim 10, wherein said first and second surfaces form an interior corner.

12. The tool of claim 1, wherein said second head comprises first and second members substantially parallel to one another and connected by a third member extending between said first and second members.

13. The tool of claim 12, wherein said third member is substantially perpendicular to said first and second members.

14. The tool of claim 12, wherein said first member is shorter than said second member.

15. A tool comprising:
a lever arm having a first end, said first end comprising a first head arranged transverse to said lever arm and including first and second substantially perpendicular surfaces; and
a removable clamp for attachment to said lever arm, wherein said clamp comprises a jaw and a fastener for attaching said clamp to said lever arm.

16. The tool of claim 15, wherein said jaw is substantially C-shaped.

17. The tool of claim 15, wherein said lever arm comprises a rectangular cross section.

18. The tool of claim 15, wherein said fastener comprises a screw, said lever arm comprising a threaded hole for receiving said screw, said clamp comprises a hole through which said screw is extended.

19. The tool of claim 15, further comprising at least one pin extending from either said lever arm or said clamp for a facilitating alignment of said clamp on said lever arm.

20. The tool of claim 15, wherein said first head opposes said jaw when said clamp is attached to said lever arm, said first head and jaw forming an open, substantially rectangular shape.

21. The tool of claim 20, wherein said first head and said clamp are sized and shaped to engage an edge connector of a printed circuit board.

22. The tool of claim 15, wherein said lever arm comprises D-2 steel, and said clamp comprises tool steel.

23. A system for removing a printed circuit edge connector comprising an elongated tool having a head at a first end, said head comprising an open channel configured for engaging said printed circuit edge connector.

24. The system of claim 23, wherein said open channel comprises a substantially rectangular shape open at only one corner.

25. The system of claim 23, wherein said channel engages at least three different sides of said edge connector.

26. The system of claim 23, wherein said elongated tool comprises a jaw connected to a handle, said jaw comprising a substantially C-shape.

27. The system of claim 26, wherein said jaw is connected to said handle by a screw.

28. The system of claim 26, further comprising at least one alignment pin extending between said jaw and said handle to facilitate connection of said jaw to said handle.

29. A method of removing an edge connector of a printed circuit board comprising:
engaging said edge connector with a tool handle;
mounting a jaw to said tool handle to clamp said edge connector to said tool handle; and
removing said edge connector by applying a force to said tool handle.

30. The method of claim 29, further comprising extending said jaw around three sides of said edge connector.

31. The method of claim 29, wherein said mounting further comprises screwing said jaw to said tool handle.

32. The method of claim 29, wherein said mounting further comprises:
aligning said jaw with said tool handle; and
securing said jaw to said tool handle.

33. The method of claim 29, wherein said applying a force to said tool handle comprises pulling or pushing substantially transverse to said tool handle.

34. A tool apparatus for removing an edge connector of a circuit board comprising:
means for engaging said edge connector around at least three sides of said edge connector; and
means for applying pressure to said means for engaging such that said edge connector is removed.

35. The tool of claim 34, wherein said means for engaging comprise a first head and a second removable head mounted in opposition to said first head.

36. The tool of claim 35, wherein said means for engaging further comprise means for securing said second head to said first head.

37. The tool of claim 36, further comprising means for aligning said second head with said first head when securing said second head to said first head.

38. The tool of claim 34, wherein said means for applying pressure comprise and elongated handle extending form said means for engaging said edge connector.
